(19) United States
(12) Patent Application Publication
(10) Pub. No.: US 2015/0304465 A1
(43) Pub. Date: Oct. 22, 2015

(54) SMART-PHONE INPUT/OUTPUT

(71) Applicant: QUALCOMM Incorporated, San Diego, CA (US)

(72) Inventors: Charles Wheeler SWEET, III, San Diego, CA (US); Jin GUO, San Diego, CA (US); Donald Bolden HUTSON, San Diego, CA (US)

(21) Appl. No.: 14/464,522

(22) Filed: Aug. 20, 2014

Related U.S. Application Data
(60) Provisional application No. 61/981,583, filed on Apr. 18, 2014.

(51) Int. Cl. H04M 1/02; G06F 13/40

(52) U.S. Cl. CPC H04M 1/0274; G06F 13/4068; H04M 2250/02; H04M 2250/04

(57) ABSTRACT

A mobile device case includes a housing configured for receiving a mobile device. The mobile device case also includes one or more general-purpose programmable input/output (I/O) ports. The one or more general-purpose programmable input/output (I/O) ports are partially integrated within the housing.

### CROSS-REFERENCE TO RELATED APPLICATION

The present application claims the benefit of U.S. Provisional Patent Application No. 61/981,583, filed on Apr. 18, 2014, in the names of Charles Wheeler SWEET III et al., the disclosure of which is expressly incorporated by reference herein in its entirety.

### BACKGROUND

1. Field

Certain aspects of the present disclosure generally relate to a mobile device case and, more particularly, to a mobile device case with integrated general-purpose programmable input/output (I/O) ports.

2. Background

Mobile devices, such as smartphones and tablets, have increasing capabilities through improved processor performance and tightly integrated sensors. With the massive scale at which such devices are produced, they could serve as powerful and cheap robot controllers. However, mobile devices are not configured with the I/O capabilities to support such uses. Furthermore, breakout I/O boards are cumbersome and difficult to integrate with mobile devices.

### SUMMARY

In one aspect, a mobile device case is disclosed. The mobile device case includes a housing configured for receiving a mobile device. The mobile device case also includes one or more general-purpose programmable input/output (I/O) ports. The one or more general-purpose programmable input/output (I/O) ports are partially integrated within the housing.

In another aspect, a method for communicating between a mobile device case and a mobile device is disclosed. The method includes receiving an electrical input signal via one or more general-purpose programmable input/output (I/O) ports of the mobile device case. The method further includes communicating the received electrical input signal to the mobile device.

In yet another aspect, a mobile device case is disclosed. The mobile device case include means for receiving an electrical input signal via one or more general-purpose programmable input/output (I/O) ports of the mobile device case. The mobile device case further includes means for communicating the received electrical input signal to a mobile device.

In still another aspect, a computer program product for communication between a mobile device case and a mobile device is disclosed. The computer program product includes a non-transitory computer readable medium having encoded thereon program code. The program code comprises program code to receive an electrical input signal via one or more general-purpose programmable input/output (I/O) ports of the mobile device case. The program code further includes program code to communicate the received electrical input signal to the mobile device.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an exemplary mobile device case with integrated I/O ports in accordance with aspects of the present disclosure.

FIG. 2 illustrates a mobile device seated within a mobile device case in accordance with an aspect of the present disclosure.

FIG. 3 is a block diagram illustrating a method for communicating between a mobile device case and a mobile device in accordance with aspects of the present disclosure.

FIGS. 4-5 are block diagrams illustrating a method for wireless communication using a mobile device case in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Aspects of the present disclosure are directed to a mobile device case. The mobile device case may be configured with programmable general-purpose input/output (I/O) ports.

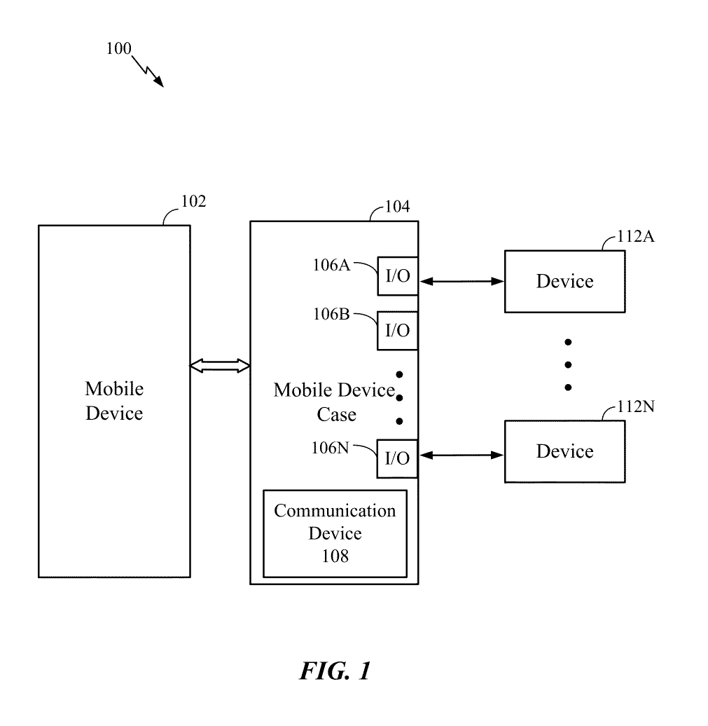

FIG. 1 is a block diagram illustrating a mobile device case for use in a mobile communication system 100 in accordance with aspects of the present disclosure. Referring to FIG. 1, a mobile device case 104 may be configured to receive a mobile device 102, such as a mobile phone, a tablet PC or other mobile communication device. The mobile device 102 may be configured with wireless communication capabilities, which may enable wireless connectivity with a communication network. For example, the mobile device 102 may be configured with a radio access technology such as Wi-Fi®, Bluetooth®, universal mobile telecommunications system (UMTS), global system for mobile (GSM), long-term evolution (LTE), and the like.

The mobile device case 104 may be configured such that the mobile device 102 may be seated within the mobile device case 104 or a portion thereof. In some aspects, the mobile device case 104 may be configured with retention portions, which may be positioned about the mobile device 102 to securely retain the mobile device 102 in position within the mobile device case 104. The mobile device case 104 may also be configured to protect the mobile device from environmental conditions and damage from impact (e.g., sudden contact with a hard surface).

The mobile device case 104 may comprise I/O ports 106A-106N. Each of the I/O ports 106A-106N may be configured to receive an electrical signal (e.g., data bits) from and/or output an electrical signal to devices 112A-112N. The I/O ports 106A-106N may be configured for general purpose I/O. In some aspects, the I/O ports 106A-106N may be configured to receive and/or output an analog signal, digital signal, pulse width modulator (PWM) signal, power signal, an inter-integrated connector (I2C) input, a serial peripheral interface (SPI) port, a controller area network (CAN) bus port, an RS-485 serial port, or a universal asynchronous receiver/transmitter (UART) port and/or the like. In one example, an I/O port (e.g., 106A-106N) may be configured to receive an electrical input signal enabling the mobile device to act as a multi-meter or other instrument.

Further, the I/O ports 106A-106N may be configured to receive a standardized connector or a header connector. For example, in some configurations, the I/O ports 106A-106N may be configured to receive an interconnection device such as a Molex or Arduino connector.

Further, in some aspects, the I/O ports 106A-106N may be programmable. That is, the data bits communicated via the I/O ports 106A-106N may be available to be read or written by the devices 112A-112N. In addition, the I/O ports 106A-106N may also be programmed to be active and/or inactive. For example, the digital input port may be active and/or inactive according to programming such that the port is active or inactive based on the occurrence of certain events or under certain conditions. In another example, an I/O port (e.g., 106A-106N) may be programmed for use in controlling a robot.

The devices 112A-112N may comprise sensors, controllers, or any I/O device compatible with a particular I/O port to which it is connected. The devices 112A-112N may also comprise an external power source, such as a mobile device charger. In some configurations, the device may comprise a microcontroller such as an Arduino Shield or other processing device. In other configurations, the device may comprise a robot, which may for example, be controlled via the mobile device 102 coupled to the mobile device case 104.

The mobile device case 104 may also be electrically coupled to the mobile device 102 to enable data communication therebetween. The connection between the mobile device 102 and the mobile device case 104 may in some aspects be wired. For example, the mobile device case 104 may be configured with a terminal to enable connection. In some configurations, the terminal may be selectively shielded from environmental conditions via a retractable covering or door.

On the other hand, the connection may be wireless. For example, the mobile device 102 may be configured to communicate with the mobile device case 104 via near field connection (NFC), Bluetooth (BT), BT low energy (BT LE), ultra-wide band, or the like.

Using the data communication path between the mobile device case 104 and the mobile device 102, the mobile device processing capabilities (e.g., processor(s) and memory) may be extended to the I/O ports 106A-106N and the coupled devices 112A-112N. For example, the processing capabilities of a mobile device 102 may drive a sensor, motor and/or other circuitry of a robot connected to the mobile device case 104 via the I/O ports 106A-106N.

In some aspects, the mobile device case 104 may be configured with a communication device 108. The communication device 108 may include one or more antennas, modems, transceivers, or other communication devices. In some aspects, the communication device 108 of the mobile device case 104 may enhance or augment the wireless connectivity of the mobile device 102. For example, the communication device 108 may augment the receive and/or transmit performance of the mobile device. The communication device 108 may also augment the transmit power of the mobile device. For example, the communication device 108 may be an antenna to improve reception for cellular, wireless local area network (WLAN), BT, GPS, or other communication of the mobile device 102.

In another example, the communication device 108 may include a modem or sub-components of a modem to enable the mobile device case 104 to support band class conversion. That is, the mobile device case 104 may be configured to act as a modem for a roaming mobile device 102 (e.g., smartphone that does not support all band classes). In this way, a user may use a mobile device 102 on travel instead of obtaining a temporary device or using a temporary SIM card in their mobile device 102.

In yet another example, the mobile device 102 may include a radio configuration. The radio configuration may include an air interface, as well as, frequency, protocol power, antenna performance, and bandwidth specifications and the like. In some aspects, the radio configuration may be provided for an operator or carrier in a given locale or region. The communication device 108 of the mobile device case 104 may also comprise a radio configuration (e.g., air interface, frequency, protocol power and bandwidth).

In some aspects, the radio configuration of the communication device 108 may be for the same or a different operator/carrier. Further, the radio configuration of the communication device 108 may be for the same or a different locale or region. As such, the mobile device 102 may operate and communicate via the radio configuration of the mobile device case 104.

In one example, a mobile device 102 including a radio configuration for an operator in a first region, may use the mobile device case 104, which includes a different radio configuration, to access a wireless communication network. Accordingly, the wireless connectivity of the mobile device 102 may be augmented.

In some aspects, the mobile device case 104 may be powered by an internal battery or other power source. The internal power source may be a battery (e.g., a rechargeable lithium-ion battery, or a disposable battery) or other power source. The mobile device case 104 may be charged via a hardwired connection and/or inductive charging or other charging techniques. In some aspects, the power of the mobile device case 104 may provide a power boost to the mobile device 102. For example, where the mobile device 102 experiences interference, the mobile device 102 may access the power cells of the mobile device case 104 to enhance the mobile device signal reception/transmission quality.

In other aspects, the mobile device case 104 may be configured to receive power via the mobile device 102. For example, the mobile device case 104 may be configured for wireless power or with an electrical connector to enable the mobile device case 104 to use the battery of mobile device 102.

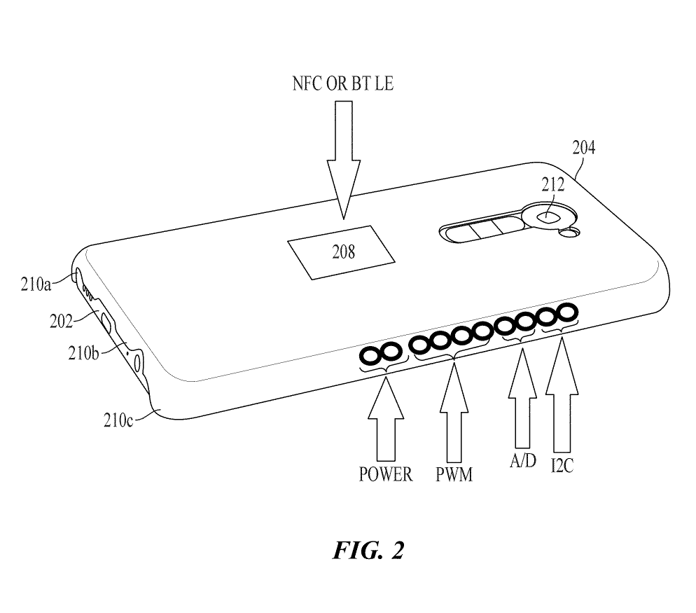

FIG. 2 illustrates an exemplary mobile device case 204 in accordance with an aspect of the present disclosure. As shown in FIG. 2, a mobile phone 202 is seated within the mobile device case 204. The mobile device case 204 is configured with retention portions 210a-210c to retain the mobile phone 202, which comprises a mobile phone in this exemplary aspect. Of course, additional retention portions may be included to secure the mobile phone 202 to the mobile device case 204. In some aspects, the mobile device case 204 may be configured to enclose or substantially enclose the mobile phone 202.

The mobile device case 204 is configured with integrated I/O ports. The I/O ports include a power terminal, and PWM, A/D and I2C ports. Again, the identified I/O ports are merely exemplary, and any number of I/O ports may be included. Further, the disclosure is not limited to the identified types of I/O ports, and other types of programmable general-purpose I/O ports may also be included.

The mobile device case 204 is also configured with a communication device 208 for wireless communication with the mobile phone 202. The wireless communication may, for example, via NFC, BT LE, or the like. The communication device 208 may provide a data communication path between the mobile device case 204 and the mobile phone 202. As such, data bits communicated via the I/O ports (e.g., PWM port or I2C port) may be available to be read by the mobile phone 202 or may be written to a device connected via the I/O ports and/or vice versa.

Further, the processing capabilities (e.g., processor(s) and memory) of the mobile phone 202 may be utilized by the I/O ports and the devices coupled thereto. In one example, probes may be connected to the analog/digital inputs on the mobile case 204. The mobile phone 202 may use the values read off of the analog/digital inputs to perform basic oscilloscope or multi-meter capabilities. In one example, the output of a multi-meter may be received via an I/O port and communicated to the mobile phone 202 via the communication device 208. The multi-meter output data may then be processed via a processor (not shown) of the mobile phone 202 and stored in memory (not shown) of the mobile phone 202.

In another example, the processing capabilities of a mobile phone 202 may drive a sensor, motor and/or other circuitry of a robot connected via the I/O ports of the mobile device case 204. Additional resources of the mobile phone 202 may also be utilized by devices coupled via the I/O ports. For example, the mobile phone camera 212 may provide visualization capabilities for a robot connected via the I/O ports.

The communication device 208 may also comprise an antenna, a modem and/or a transceiver. In some aspects, the communication device 208 of the mobile device case 204 may augment the wireless connectivity of the mobile device 202. For example, the communication device 208 may comprise an antenna to improve reception for cellular, wireless local area network (WLAN), BT, GPS, or other communication of the mobile phone 202.

In one exemplary aspect, the communication device 208 may comprise a modem to enable the mobile device case 204 to support band class conversion. That is, the mobile device case 204 may be configured to act as a modem for a roaming mobile phone 202. In this way, a user may use a mobile phone 202 on travel without obtaining a temporary device or using a temporary SIM card in their mobile phone 202 to interface with the radio access network at the travel destination.

In one configuration, a mobile device case is configured for receiving an I/O connection and communicating information received to a mobile device. The mobile device case includes a receiving means and/or communicating means. In one aspect, the receiving means may be I/O ports 106A-106N and the communicating means may be the communication device 108 or communication device 208 configured to perform the functions recited. In another configuration, the aforementioned means may be any element, module or apparatus configured to perform the functions recited by the aforementioned means.

In another configuration, a mobile device case is configured for receiving a wireless communication signal and communicating information corresponding to the wireless communication signal to a mobile device in communication with the mobile device case. The mobile device case includes a receiving means and/or communicating means. In one aspect, the receiving means may be I/O ports 106A-106N and the communicating means may be the communication device 108 or communication device 208 configured to perform the functions recited. In another configuration, the aforementioned means may be any element, module or apparatus configured to perform the functions recited by the aforementioned means.

In yet another configuration, a mobile device case is configured for receiving a wireless communication signal and augmenting the wireless connectivity of the mobile device associated with the mobile device case. The mobile device case includes a receiving means and/or augmenting means. In one aspect, the receiving means may be I/O ports 106A-106N, communication device 108 or communication device 208 and the augmenting means may be the communication device 108 or communication device 208 configured to perform the functions recited. In another configuration, the aforementioned means may be any element, module or apparatus configured to perform the functions recited by the aforementioned means.

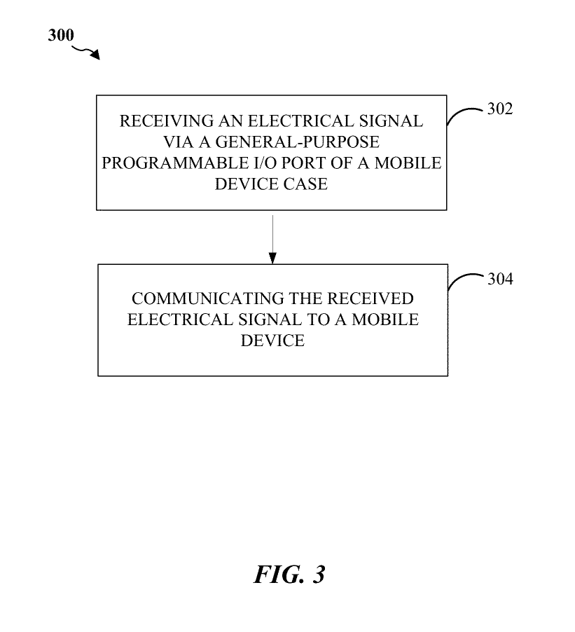

FIG. 3 illustrates a method 300 for communicating between a mobile device case and mobile device in accordance with aspects of the present disclosure. In block 302, the process receives an electrical signal via a general-purpose programmable input/output (I/O) port of the mobile device case. In some aspects, the availability of the electrical signal may be determined based on programming associated with a device coupled to the mobile device case. The electrical signal may comprise data bits that may be read by the mobile device or may be output to the device via the mobile device case.

Furthermore, in block 304, the process communicates the received electrical signal to the mobile device. The electrical signal may be provided to the mobile device with a wired or wireless connection. For example, the electrical signal may be supplied via NFC or BT connection.

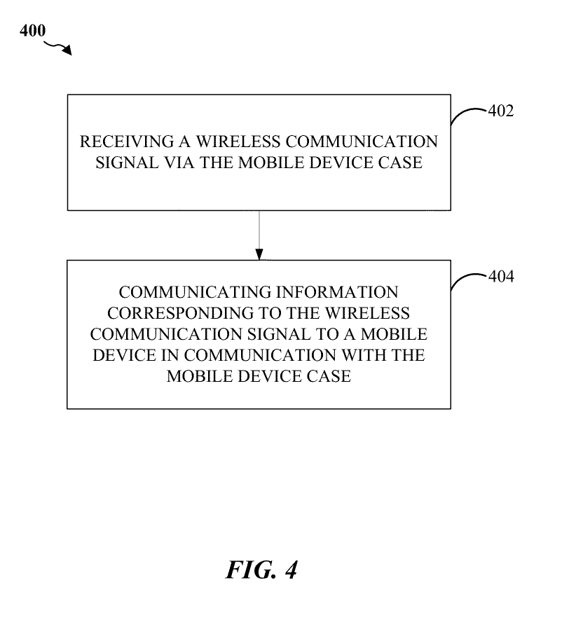

FIG. 4 illustrates a method 400 for wireless communication using a mobile device case in accordance with aspects of the present disclosure. In block 402, the process receives a wireless communication signal via the mobile device case. Furthermore, in block 404, the process communicates information corresponding to the wireless communication signal to a mobile device in communication with the mobile device case.

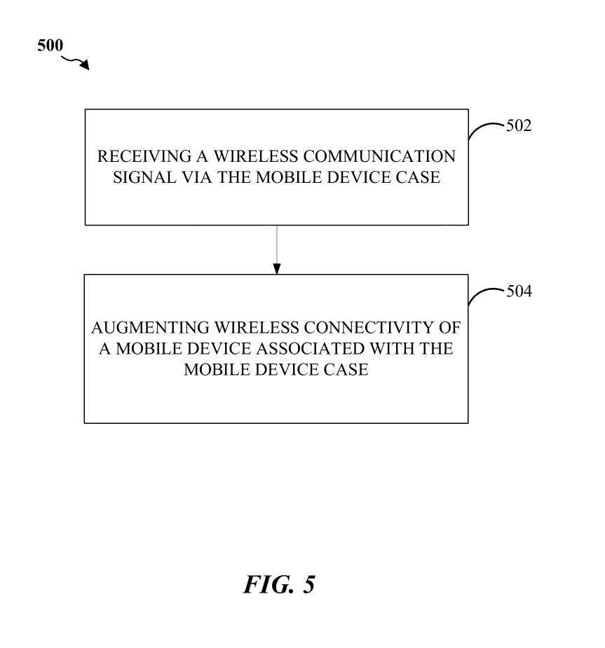

FIG. 5 illustrates a method 500 for wireless communication using a mobile device case associated with a mobile device having wireless connectivity in accordance with aspects of the present disclosure. In block 502, the process receives a wireless communication signal via the mobile device case. Furthermore, in block 504, the process augments the wireless connectivity of the mobile device associated with the mobile device case. In some aspects, the mobile device may be coupled to the mobile device case. In other aspects, the mobile device may be in communication with the mobile device case.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A mobile device case, comprising:
a housing configured for receiving a mobile device; and
at least one general-purpose programmable input/output (I/O) port, the at least one I/O port being at least partially integrated within the housing.

2. The mobile device case of claim 1, in which the at least one I/O port includes at least one of an analog output port, digital output port, pulse width modulation port, an inter-integrated circuit (I2C) port, a serial peripheral interface (SPI) port, a controller area network (CAN) bus port, an RS-485 serial port, or a universal asynchronous receiver/transmitter (UART) port.

3. The mobile device case of claim 1, in which the at least one I/O port comprises a standardized connector.

4. The mobile device case of claim 3, in which the mobile device case is configured to couple with a header connector.

5. The mobile device case of claim 4, in which the header connector comprises an interconnection connector.

6. The mobile device case of claim 1, in which the mobile device is a mobile telephone.

7. The mobile device case of claim 6, in which the mobile telephone provides processing capability for devices coupled via the at least one I/O port.

8. A method for communicating between a mobile device case and a mobile device, comprising:
receiving an electrical input signal via at least one general-purpose programmable (I/O) port of the mobile device case; and
communicating the received electrical input signal to the mobile device.

9. The method of claim 8, in which the at least one I/O port comprises at least one of an analog output port, digital output port, pulse width modulation port, an inter-integrated circuit (I2C) port, a serial peripheral interface (SPI) port, a controller area network (CAN) bus port, an RS-485 serial port, or a universal asynchronous receiver/transmitter (UART) port.

10. The method of claim 8, in which the at least one I/O port comprises a standardized connector.

11. The method of claim 10, in which the electrical input signal is received via a header connector coupled to the mobile device case.

12. The method of claim 11, in which the header connector comprises an interconnection connector.

13. The method of claim 8, in which the mobile device is a mobile telephone.

14. The method of claim 13, further comprising processing, via the mobile telephone, the electrical input signal received via the at least one I/O port.

15. A mobile device case, comprising:
means for receiving an electrical input signal via at least one general-purpose programmable (I/O) port of the mobile device case; and
means for communicating the received electrical input signal to a mobile device.

16. The mobile device case of claim 15, in which the at least one I/O port includes at least one of an analog output port, digital output port, pulse width modulation port, an inter-integrated circuit (I2C) port, a serial peripheral interface (SPI) port, a controller area network (CAN) bus port, an RS-485 serial port, or a universal asynchronous receiver/transmitter (UART) port.

17. The mobile device case of claim 15, in which the at least one I/O port comprises a standardized connector.

18. The mobile device case of claim 17, in which the mobile device case is configured to couple with a header connector.

19. The mobile device case of claim 18, in which the header connector comprises an interconnection connector.

20. A computer program product for communicating between a mobile device case and a mobile device, comprising:
a non-transitory computer readable medium having encoded thereon program code, the program code comprising:
program code to receive an electrical input signal via at least one general-purpose programmable (I/O) port of the mobile device case; and
program code to communicate the received electrical input signal to the mobile device.
